(19) United States
(12) Patent Application Publication
(10) Pub. No.: US 2003/0034122 A1
(43) Pub. Date: Feb. 20, 2003

(54) Unfired-ceramic-body procesing method

(75) Inventor: Koichi Asai, Nagoya-shi (JP)

Correspondence Address: OLIFF & BERRIDGE, PLC, P.O. BOX 19928, ALEXANDRIA, VA, 22320, US

(73) Assignee: FUJI MACHINE MFG. CO., LTD., Chiryu-shi (JP)

(21) Appl. No.: 10/206,332

(22) Filed: Jul. 29, 2002

(30) Foreign Application Priority Data
Aug. 10, 2001 (JP) 2001-245091

(51) Int. Cl. B32B 31/00

(52) U.S. Cl. 156/252

(57) ABSTRACT

A method of processing an unfired ceramic body or sheet, including the steps of covering, with a cover, a surface of the unfired ceramic body or sheet, such that a portion of the surface of the unfired ceramic body or sheet is exposed, and removing at least a portion of the unfired ceramic body that defines the exposed portion of the surface of the unfired ceramic body, and thereby forming a dent, a dimple, or a through-hole in an exposed portion of the unfired ceramic body or sheet.

### BACKGROUND OF THE INVENTION

1. Field of the Invention

The present invention relates to a method of processing an unfired or unburned ceramic body and particularly to such a method comprising a step of forming a dent, a dimple, or a through-hole in an unfired ceramic body.

2. Discussion of Related Art

It has been practiced to form a dent, a dimple, or a through-hole in an unfired ceramic body. For example, Japanese Patent Document No. 7-22734 discloses a method of forming a through-hole through the thickness of an unfired ceramic sheet, i.e., a green sheet that is to be used to produce an electric component such as a multiple-layer ceramic wiring board or a ceramic capacitor. At least one circuit pattern is formed on at least one of opposite surfaces of a green-sheet, and a plurality of green sheets are stacked on each other and then are fired to produce a multiple-layer ceramic wiring board. In this case, it is needed to electrically connect the respective circuit patterns of the green sheets to each other. To this end, an appropriate number of through-holes are formed in respective appropriate portions of each green sheet, through the thickness thereof, and are filled with an electrically conductive material to produce respective electrically conductive portions of the each green sheet through which the circuit patterns are electrically connected to each other.

In the conventional method, the through-holes are formed by punching of a press machine, cutting of a drill machine, or holing of a laser device. However, the punching needs metallic dies, which leads to increasing the cost; and the sequential formation of through-holes by the drilling or the laser device needs much time. Thus, the conventional method need to be improved.

### SUMMARY OF THE INVENTION

It is therefore an object of the present invention to form, using inexpensive equipment and with high efficiency, a dent, a dimple, or a through-hole (hereinafter, referred to as the through-hole or the like) in an unfired ceramic body such as a green sheet. This object may be achieved according to any one of the following modes of the present invention in the form of an unfired-ceramic-body processing method, each of which is numbered like the appended claims and may depend from the other mode or modes, where appropriate, to indicate and clarify possible combinations of technical features. It is, however, to be understood that the present invention is not limited to the technical features or any combinations thereof that will be described below for illustrative purposes only. It is to be further understood that a plurality of elements or features included in any one of the following modes of the invention are not necessarily provided altogether, and that the invention may be embodied without some of the elements or features described with respect to the same mode.

(1) A method of processing an unfired ceramic body, comprising the steps of covering, with a cover, a surface of the unfired ceramic body, such that a portion of the surface of the unfired ceramic body is exposed, and removing at least a portion of the unfired ceramic body that defines the exposed portion of the surface of the unfired ceramic body, and thereby forming at least a dent in an exposed portion of the unfired ceramic body.

According to this mode, a portion of a surface of an unfired ceramic body is covered by a cover, and another portion of the surface is not covered by the cover. Thus, a dent, a dimple, or a through-hole can be formed by removing the exposed portion of the unfired ceramic body that is not covered by the cover. For example, in the case where the cover has a number of through-holes, a number of through-holes can be formed in the unfired ceramic body, and at least a portion of those through-holes can be simultaneously formed. Thus, the efficiency of formation of through-holes can be improved. In addition, since it is considerably easy to form a plurality of through-holes in the cover, as will be described later, the cost needed to carry out the present method can be reduced.

(2) A method according to the mode (1), wherein the step of covering comprises producing the cover separately from the unfired ceramic body, and holding, with a holder, the cover such that the cover is kept in close contact with the surface of the unfired ceramic body.

The cover may be a mask that is produced by forming one or more through-holes in a metallic plate, and the mask may be held by a holder such that the mask is kept in close contact with the surface of the unfired ceramic body. Thus, only a portion of the surface of the unfired ceramic body is covered by the mask.

(3) A method according to the mode (1), wherein the step of covering comprises bonding the cover to the surface of the unfired ceramic body, and wherein the method further comprises the step of separating, after the step of removing, the cover from the surface of the unfired ceramic body.

The cover may be a protective layer (e.g., a printed layer) that is formed of a material (e.g., an ink) having excellent mechanical or chemical properties, such as impact resistance, wearing resistance, or water resistance, such that the protective layer partly covers the surface of the unfired ceramic body. It is preferred that the protective layer be one that can be, after use, peeled off or dissolved, because it may be needed to form a circuit pattern directly on the surface of the unfired ceramic body. However, the circuit pattern may be formed on the protective layer. In the latter case, the protective-layer removing step can be omitted.

(4) A method according to any of the modes (1) to (3), wherein the step of removing comprises causing an active medium to act on the exposed portion of the surface of the unfired ceramic body, and at least a portion of the cover that is adjacent to the exposed portion of the surface, and thereby physically removing at least the portion of the unfired ceramic body that defines the exposed portion of the surface.

According to this mode, an active medium acts on the exposed portion of the surface of the unfired ceramic body, and at least a portion of the cover that is adjacent to the exposed portion of the surface. Thus, the portion of the unfired ceramic body that is covered by the cover is not removed because of protection of the cover, and only the exposed portion is removed to easily form a dent, a dimple, or a through-hole.

(5) A method according to the mode (4), wherein the active medium comprises a solid.

A solid active medium may be a shot or a brush. The shot may be mechanically given a kinetic energy by, e.g., a rotary blade, or may be blown with gas from a nozzle, so that the shot hits the cover and the unfired ceramic body. Thus, the shot removes the exposed portion of the unfired ceramic body, thereby forming a through-hole or the like. This process is called “shot blast”. The shot may be provided by any appropriate material. However, it is noted that the greater specific gravity the material has, the greater kinetic energy the shot can be given. If the shot is provided by a material having a small particle diameter, the through-hole or the like can be formed with highly accurate dimensions, but the efficiency of formation thereof is lowered. Thus, it is preferred to use such a shot that is provided by a material having the highest possible specific gravity, so as to improve the efficiency. If the shot is provided by the same sand as the sand as the material of the unfired ceramic body, such an advantage is obtained that a portion of the sand can be left, without any problems, on the unfired ceramic body. Shot blast in which sand is used is called “sand blast”. Shot blast is advantageous in that a plurality of through-holes or the like can be easily formed at once and that the cost needed to carry out it is low.

(6) A method according to the mode (4) or (5), wherein the active medium comprises a liquid.

A liquid active medium may be water or a solvent. Water or a solvent is used to remove the exposed portion of the unfired ceramic body. The liquid active medium may be solely applied to the object, or may be blown with gas to be applied to the object. In the latter case, the liquid active medium is used with the gas active medium. The above-described solid active medium may be used with the liquid active medium.

(7) A method according to any of the modes (4) to (6), wherein the active medium comprises a gas.

A gas active medium may be a compressed air. The gas active medium may be solely used such that the gas is blown at so high a speed that the gas can remove the exposed portion of the unfired ceramic body. However, for the purpose of improving the efficiency of working, it is preferred to use the gas active medium with the solid or liquid active medium.

(8) A method according to any of the modes (1) to (7), wherein the unfired ceramic body comprises an unfired ceramic sheet, and wherein the step of removing comprises removing at least one portion of the unfired ceramic sheet that is not covered by the cover, and thereby forming at least one through-hole through a thickness of the unfired ceramic sheet.

One or more through-holes formed in the unfired ceramic sheet may be one or ones that are used to produce one or more electrically conductive portions in the unfired ceramic sheet; positioning through-holes that are used when a plurality of unfired ceramic sheets are stacked on each other to produce a multiple-layer ceramic wiring board; or an array of through-holes that are used to produce, in the unfired ceramic sheet, a perforated portion that will be described according to the following mode (9). According to this mode, two or all of the through-holes corresponding to the electrically conductive portions, the positioning through-holes, or the array of through-holes corresponding to the perforated portion can be formed in a single step. In the last case, the efficiency of working can be improved.

(9) A method according to the mode (8), wherein the step of removing comprises forming a plurality of through-holes along a single line in the unfired ceramic sheet, and thereby providing a perforated portion of the unfired ceramic sheet.

Each of the through-holes may be any sort of hole, such as a circular hole, an elongate hole, or a rectangular hole.

(10) A method according to the mode (9), further comprising the step of bonding a support sheet to an opposite surface of the unfired ceramic sheet that is opposite to the surface thereof covered by the cover.

Since the unfired ceramic sheet is supported by the support sheet, it can be easily handled. The support sheet is separated from the unfired ceramic sheet, i.e., green sheet at an appropriate timing before the green sheet is fired. However, it is possible to form a through-hole or the like in a green sheet that is not supported by a support sheet. In the latter case, a green sheet may be conveyed, or subjected to a hole-forming step, on a green-sheet supporter, such as a conveyor belt.

(11) A method according to the mode (9) or (10), wherein the step of covering comprises covering, with a first cover having a plurality of first through-holes formed along a single line, the surface of the unfired ceramic sheet, such that the first cover is kept in close contact with the unfired ceramic sheet, wherein the step of removing comprises forming, in the unfired ceramic sheet, an array of through-holes corresponding to the plurality of first through-holes of the first cover, wherein the step of covering further comprises covering, with a second cover having at least one second through-hole corresponding to at least one portion of the first cover that is located between at least one pair of adjacent first through-holes of the plurality of first through-holes, the unfired ceramic sheet having the array of through-holes, such that the second cover is kept in close contact with the unfired ceramic sheet, and wherein the step of removing further comprises removing at least one portion of the unfired ceramic sheet that is located between at least one pair of adjacent through-holes of the array of through-holes, and thereby connecting the array of through-holes with each other so as to form a slit.

The unfired ceramic sheet may be cut into a plurality of divided sheets. In this case, since the unfired ceramic sheet has the slit, it can be easily separated into the divided sheets. Alternatively, when the slit is formed, the unfired ceramic sheet may be completely separated into the divided sheets. If a plurality of slits are formed in series, the unfired ceramic sheet can be easily separated into the divided sheets; and if a continuous single slit is formed, the unfired ceramic sheet is separated into the divided portions at the same time as the time of formation of the slit. If the unfired ceramic sheet is supported by a support sheet, described according to the following mode (12), the divided sheets are prevented from being apart from each other.

(12) A method according to the mode (11), further comprising the step of bonding a support sheet to an opposite surface of the unfired ceramic sheet that is opposite to the surface thereof covered by the cover.

(13) A method according to the mode (9), wherein the step of covering comprises covering, with a first cover having a plurality of first through-holes formed along a single line, the surface of the unfired ceramic sheet, such that the first cover is kept in close contact with the unfired ceramic sheet, wherein the step of removing comprises forming, in the unfired ceramic sheet, an array of through-holes corresponding to the plurality of first through-holes of the first cover, wherein the step of covering further comprises covering, with a second cover having at least one second through-hole corresponding to at least one portion of the first cover that is located between at least one pair of adjacent first through-holes of the plurality of first through-holes, the unfired ceramic sheet having the array of through-holes, such that the second cover is kept in close contact with the unfired ceramic sheet, and wherein the step of removing further comprises forming at least one through-hole in at least one portion of the unfired ceramic sheet that is located between at least one pair of adjacent through-holes of the array of through-holes.

The less the portion of the unfired ceramic sheet that is located between the pair of adjacent through-holes of the array of through-holes is, the easier the separation of the unfired ceramic sheet into divided sheets is. However, in the case where a single cover is used to form that portion that is very small, the strength or durability of the single cover must lower. According to this mode, however, since the first and second covers are employed, the strength of those covers need not lower, and the separation of the unfired ceramic sheet into the divided sheets can be easily carried out.

(14) A method according to the mode (9) or (10), wherein, further comprising the step of bonding a support sheet to an opposite surface of the unfired ceramic sheet that is opposite to the surface thereof covered by the cover.

(15) A method according to any of the modes (8) to (14), further comprising the step of forming, in the unfired ceramic sheet, at least one electrically conductive portion by filling the at least one through-hole of the unfired ceramic sheet with at least one electrically conductive body, and forming an electrically conductive layer on at least one of the opposite surfaces of the unfired ceramic sheet.

(16) A method according to the mode (15), wherein the step of forming the at least one electrically conductive layer comprises forming, on the at least one of the opposite surfaces of the unfired ceramic sheet, at least one circuit pattern which is electrically connected to the at least one electrically conductive portion of the unfired ceramic sheet.

If a plurality of unfired ceramic sheets each of which has a circuit pattern formed thereon are stacked on each other and are fired, a multiple-layer ceramic wiring board is obtained. If a plurality of unfired ceramic sheets each of which has, in place of a circuit pattern, an electrically conductive layer covering a substantially entire surface thereof are stacked on each other and are fired, a ceramic capacitor is obtained.

### BRIEF DESCRIPTION OF THE DRAWINGS

The above and other objects, features, advantages and technical and industrial significance of the present invention will be better understood by reading the following detailed description of preferred embodiments of the invention, when considered in connection with the accompanying drawings, in which:

FIG. 1 is an illustrative view for explaining a production line for carrying out the step of producing a green sheet, as part of a multiple-layer ceramic wiring board producing method to which the present invention is applied;

FIG. 2 is an illustrative view for explaining another production line for carrying out the step of processing the green sheet into a multiple-layer ceramic wiring board, as part of the multiple-layer ceramic wiring board producing method;

FIG. 3 is a partly cross-sectional, illustrative view for explaining the step of forming holes in the green sheet, as part of the multiple-layer ceramic wiring board producing method;

FIG. 4 is a plan view for explaining through-holes formed in the hole-forming step;

FIG. 5 is a plan view for explaining different through-holes formed in the hole-forming step;

FIG. 6 is a partly cross-sectional, illustrative view for explaining a different hole-forming step as part of another multiple-layer ceramic wiring board producing method as a second embodiment of the present invention;

FIG. 7 is a plan view of one layer of a multiple-layer ceramic board that is produced in the first embodiment shown in FIGS. 1 to 5 or the second embodiment shown in FIG. 6; and

FIG. 8 is a partly cross-sectional, illustrative view for explaining a different hole-forming step as part of yet another multiple-layer ceramic wiring board producing method as a third embodiment of the present invention.

### DETAILED DESCRIPTION OF THE PREFERRED EMBODIMENTS

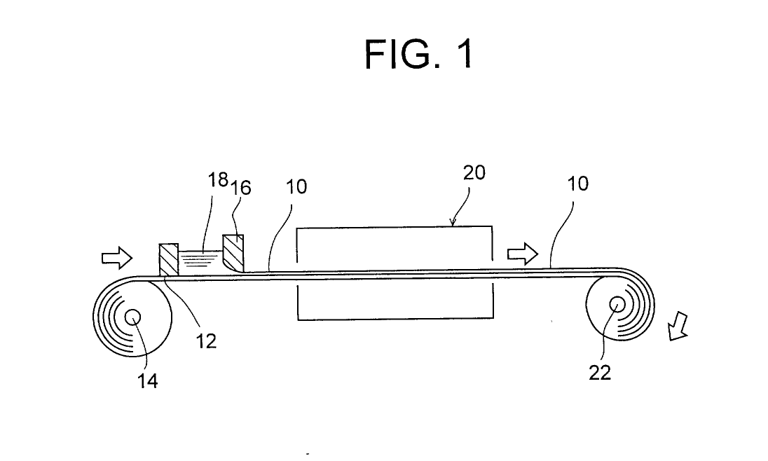

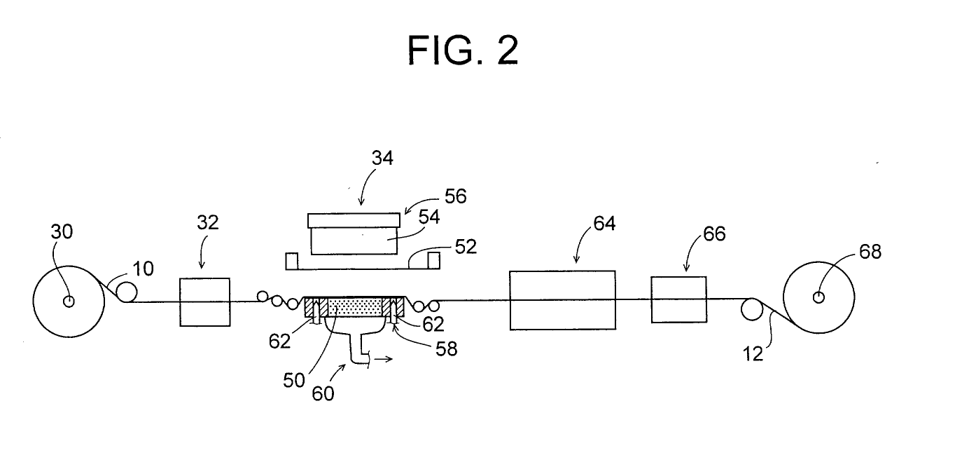

Hereinafter, there will be described an embodiment of the present invention that is applied to production of a multiple-layer ceramic wiring board. The multiple-layer ceramic wiring board is produced in steps shown in FIGS. 1 and 2. FIG. 1 shows a line for producing a green sheet 10 as an example of an unfired or unburned ceramic sheet. More specifically described, a support sheet 12 formed of a synthetic resin such as polyethylene terephthalate (PET) is drawn, in the form of a web, from a supply roll 14, and a ceramic slurry 18 is applied by a doctor-blade device 16 to an upper surface of the support sheet 12. The ceramic slurry 18 applied to the support sheet 12 is dried by a drying device 20, so that the green sheet 10 having a prescribed uniform thickness is formed on the support sheet 12. The green sheet 10 and the support sheet 12 are taken up by a take-up roll 22. Before the green sheet 10 is taken up by the take-up roll 22, an appropriate number of slits are preferably formed in the green sheet 10 such that the slits extend in a lengthwise direction of the sheet 10, so that the sheet 10 are divided into a plurality of webs. The slurry 18 is, e.g., a mixture of a ceramic powder such as alumina, a binder such as polyvinyl butyral, a dispersant such as ester of phthalic acid, glycol, or ketone or its derivatives, and a solvent.

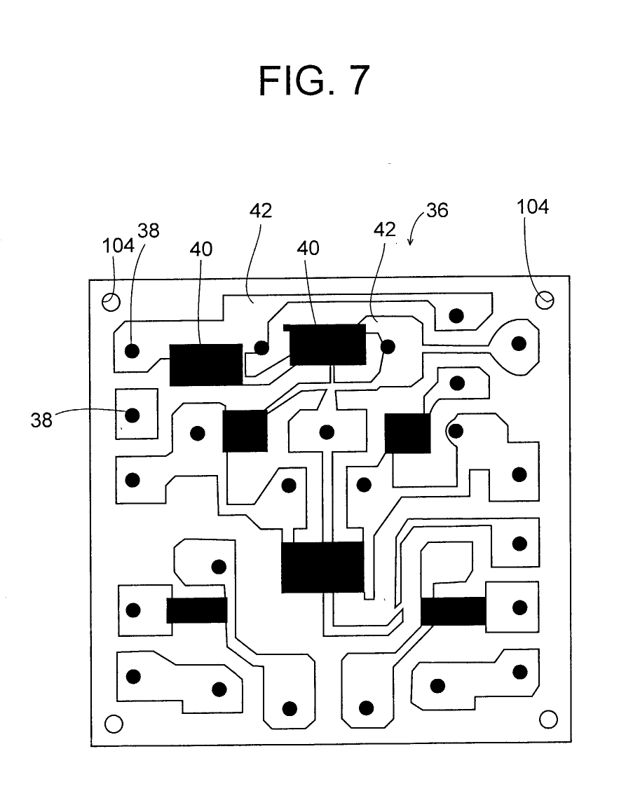

The green sheet 10 supported by the support sheet 12, produced in the above-described manner, is drawn from a supply roller 30, as illustrated in FIG. 2, and a number of through-holes are formed in the green sheet 10 by a hole-forming device 32, described later. After the hole-forming step, the green sheet 10 is sent to a printing device 34, which fills the through-holes of the sheet 10 with electrically conductive paste, thereby forming electrically conductive portions of the sheet 10, and simultaneously prints an electrically conductive pattern on an upper surface of the sheet 10. Finally, the green sheet 10 is processed into a ceramic wiring board 36, shown in FIG. 7. In FIG. 7, the above-described electrically conductive portions are indicated by black circles 38; resistance portion formed by printing of resistance paste are indicated by black rectangles 40; and the electrically conductive pattern that electrically connects the conductive portions 38 and the resistance portions 40 is indicated by 42. Hereinafter, the conductive portions 38, the resistance portions 40, and the conductive pattern 42 will be referred to as a circuit pattern.

The printing device 34 includes a support table 50 formed of a porous material; a screen 52 having through-holes corresponding to the conductive portions 38 and the conductive pattern 42; a squeegee device 56 including a squeegee 54 movable along the screen 52; a positioning device 58; and a suction device 60. The positioning device 58 includes an elevating and lowering device, not shown, and a plurality of positioning pins 62 that are elevated by the elevating and lowering device to project from an upper surface of the support table 50 and fit in respective positioning pins, not shown, of the green sheet 10, so as to position the sheet 10. The suction device 60 sucks air through the porous body of the support table 50, and applies suction to the support sheet 12 supporting the green sheet 10, thereby fixing the support sheet 12 to the support table 50. FIG. 2 shows the single printing device 34. However, in fact, a plurality of printing devices 34 are employed to print different inks or pastes than the electrically conductive paste; such as the above-described resistance paste.

After the printing of the printing device 34, the green sheet 10 is dried by a drying device 64, and then a separating device 66 separates, from the support sheet 12, individual sheets each corresponding to a ceramic board, and a take-up roll 68 takes up the support sheet 12 left. A plurality of individual separate sheets, each corresponding to a ceramic board, are stacked on each other. For example, several sheets to several tens of sheets are stacked on one another. In the case of a ceramic capacitor, more than several hundreds of sheets are stacked on one another. The thus stacked sheets are cut as needed, and are fired in a continuous pressure kiln to produce a multiple-layer ceramic wiring board or a ceramic capacitor.

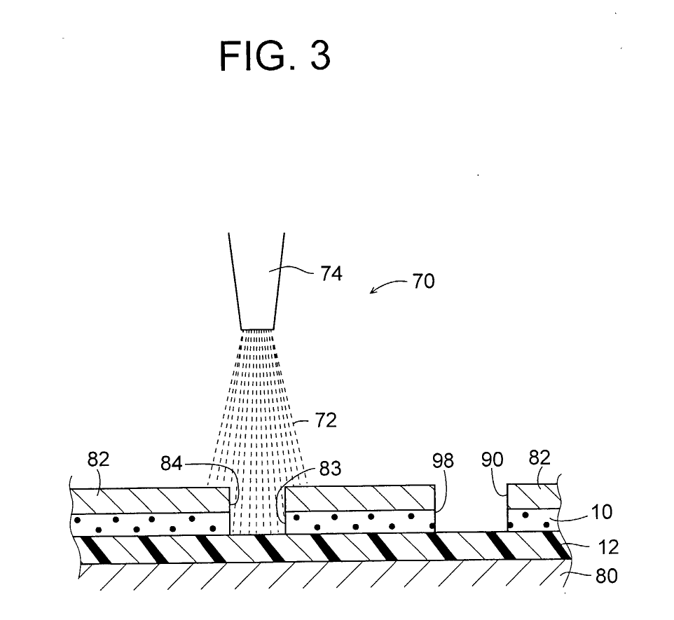

Next, the above-mentioned hole-forming step will be described in detail. In the present embodiment, the hole-forming device 32 includes a sand-blasting device 70 shown in FIG. 3. Since the sand-blasting device 70 is known in the art, it is not described here. However, the sand-blasting device 70 uses, as sand 72, the same material as that of the green sheet 10. the sand-blasting device 70 blows, through a nozzle 74, the sand 72 with compressed air, toward the green sheet 10. Alternatively, it is possible to employ a rotary blade or the like that splashes the sand 72 toward the green sheet 10. In addition, it is possible to employ, as shot, metallic powder or the like. In the present embodiment, the step in which the sand 72 is used to remove a portion of the green sheet 10 is a removing step.

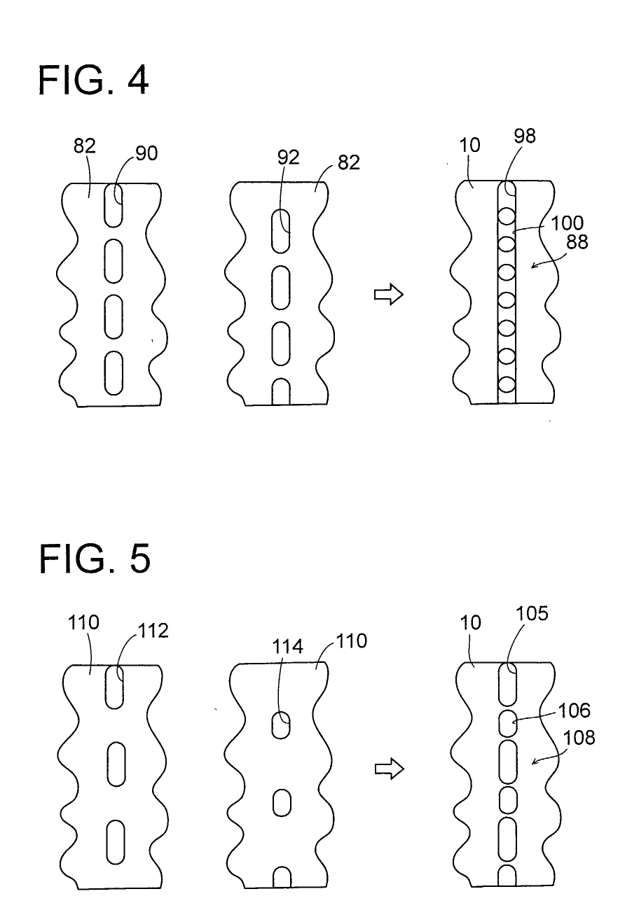

The green sheet 10 is supported by the support sheet 12, which in turn is supported by a support table 80. A mask 82 is placed on an upper surface of the green sheet 10 that is opposite to a lower surface thereof supported by the support table 80. The mask 82 has through-holes 84 for forming, in the green sheet 10, through-holes 83 corresponding to the electrically conductive portions 38, and additionally has through-holes 90 for forming, in the green sheet 10, a perforation where a portion corresponding to a ceramic board is to be separated from a remaining portion of the green sheet 10. In the present embodiment, a plurality of shot-blasting devices (e.g., a plurality of sand-blasting devices) 70 are employed and, for example, an upstream-side shot-blasting device 70 is used with the mask 82 having the through-holes 90, and a downstream-side shot-blasting device 70 is used with another mask 82 having through-holes 92 shown in FIG. 4. The through-holes 92 of the mask 82 are used to form, in the green sheet 10, through-holes 100 which overlap the through-holes 98 to form a separation groove or slit 88. That is, the through-holes 92 cooperate with the through-holes 90 to form the separation slit 88 in the green sheet 10. It is possible to employ two separate masks one of which has the through-holes 84 for forming the through-holes 83 corresponding to the conductive portions 38, and the other of which has the through-holes 90 for forming the through-holes 98 as part of the separation slit 100. Each mask 82 is held by a mask holder, not shown, such that the mask 82 is movable to an operative position where the mask 82 is kept in close contact with the green sheet 10 and to a retracted position where the mask 82 is kept away from the sheet 10. In the present embodiment, the step in which each mask 82 is used to cover the greens sheet 10 is a covering step.

The masks 82 are formed of metal and accordingly the through-holes 84, 90, 92 can be easily formed by, e.g., etching. That is, a metallic plate is masked with a chemically stable material except for respective portions corresponding to the through-holes 84, 90, 92, and only those portions corresponding to the through-holes 84, 90, 92 are removed. However, the masks 82 may be formed of any of other known materials, or may be produced in any of other known methods. For example, masks may be mechanically formed of a material that is easily mechanically workable.

The hole-forming device 32 includes, in addition to the sand-blasting devices 70, a positioning-hole forming device which forms, using, e.g., a punch or a drill, through-holes in both the green sheet 10 and the support sheet 12. More specifically described, the positioning-hole forming device forms positioning holes in which the positioning pins 62 of the printing device 34 are to fit to position the green sheet 10; and positioning holes 104 shown in FIG. 7.

In the present embodiment, each separation slit 88 is sequentially formed in the web of green sheet 10, to separate each individual sheet corresponding to a ceramic board. However, as shown in FIG. 5, it is possible to form, in the green sheet 10, a perforated portion 108 having a first array of through-holes 105 and a second array of through-holes 106 that are not connected to one another to form an elongate slit like the separation slit 88. To this end, a first mask 110 having through-holes 112, and then a second mask 110 having through-holes 114 are used, each with sand, to form the through-holes 105 and then the through-holes 106, respectively. The shape and/or size of the through-holes 112 may be identical with, or different from, those of the through-holes 114. Likewise, the shape and/or size of the through-holes 90 may be identical with, or different from, those of the through-holes 92.

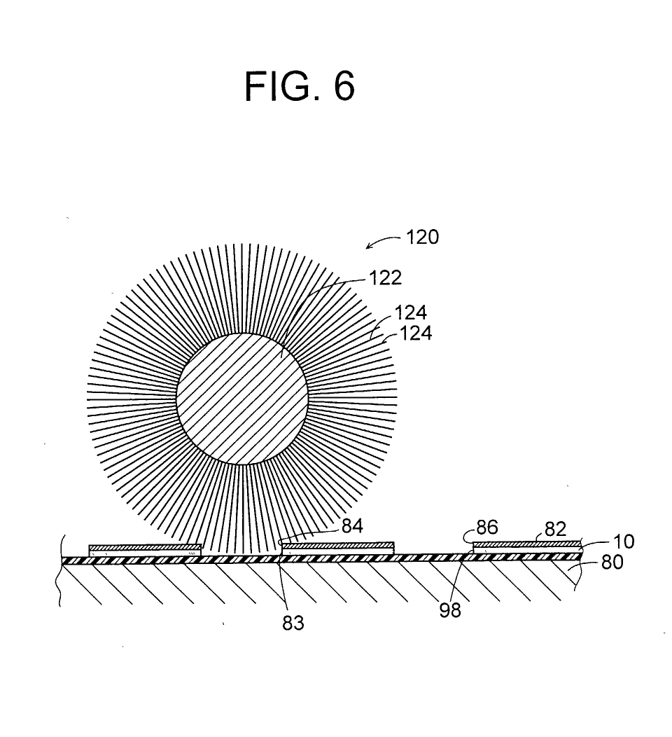

For the purpose of forming the through-holes 83 corresponding to the conductive portions 38, the through-holes 98, 100 corresponding to the separation slit 88, or the through-holes 105, 106 corresponding to the perforated portion 108, the hole-forming device 32 may employ a brush 120 shown in FIG. 6. The brush 120 includes a rotary shaft 122 and metallic or synthetic-resin fibers 124 extending radially outwardly from an outer circumferential surface of the rotary shaft 122. When the brush 120 is rotated by a drive device, not shown, tip portions of the fibers 124 act on the green sheet 10 covered with the mask 82, and a portion of the green sheet 10 that corresponds to the through-hole 84 of the mask 82 is removed to form the through-hole 83. Likewise, the through-holes 98, 100 corresponding to the separation slit 88 and the through-holes 105, 106 corresponding to the perforated portion 108 are formed.

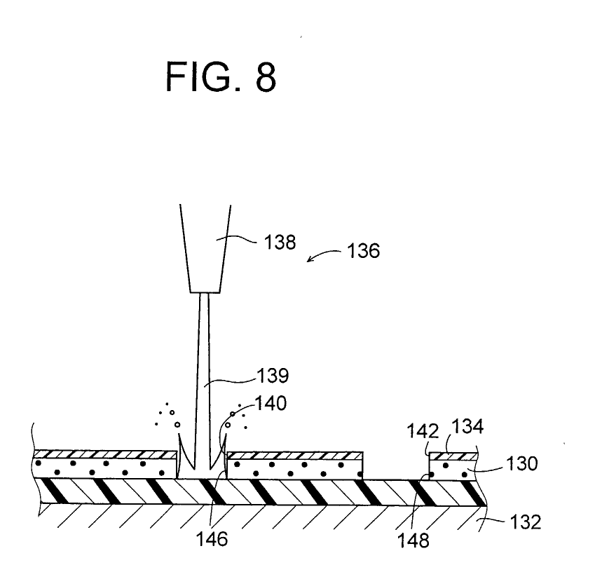

The through-holes 83, 98, 100, 105, 106 may be formed in a different method. FIG. 8 shows an example in which a green sheet 130 is supported by a support sheet 132 and is covered by a protection layer 134 as a sort of cover. A hole-forming device 136 includes a nozzle 138 which spouts water 139 as a sort of a liquid medium, so that the water 139 removes portions of the green sheet 130 that correspond to through-holes 140, 142 of the protective layer 134, and thereby forms through-holes 146, 148 in the sheet 130. The protective layer 134 is formed of a material that is resistant to water and is soluble in a solvent and, after the hole-forming step, the protective layer 134 is removed by the solvent. Alternatively, the protective layer 134 may be peeled off the green sheet 130.

The perforated portion 108 is defined by the through-holes 105 and the through-holes 106 both of which are formed in a portion of the single green sheet 10 that corresponds a ceramic board. However, it is possible to form the through-holes 105 and the through-holes 106 in respective different portions of the green sheet 10 that correspond to two ceramic boards to be stacked on each other. In this case, it can be said that the thickness of the respective perforated portions 108 of the two ceramic boards stacked on each other is substantially half that of the remaining portions of the same. Therefore, the perforated portions 108 of the two ceramic boards stacked can be easily separated in a subsequent, separating step. The separating step may be carried out after a plurality of ceramic boards stacked on each other are fired into a multiple-layer ceramic wiring board. This method may apply to the separation slit 88 that is defined by the through-holes 98 and the through-holes 100.

The foregoing description relates to the embodiment in which the principle of the present invention is applied to the production of electric components such as multiple-layer ceramic wiring boards or ceramic capacitors, particularly, to the formation of through-holes in green sheets in the production of electric components. However, the present invention is applicable to other fields, e.g., to the formation of through-holes in mechanical ceramic components, or the formation of dents or dimples in various things such as electric or mechanical components.

It is to be understood that the present invention may be embodied with various changes, modifications and improvements, such as those described in SUMMARY OF THE INVENTION, which may occur to a person skilled in the art, without departing from the spirit and scope of the invention defined in the appended claims.

What is claimed is:

1. A method of processing an unfired ceramic body, comprising the steps of:
covering, with a cover, a surface of the unfired ceramic body, such that a portion of the surface of the unfired ceramic body is exposed, and
removing at least a portion of the unfired ceramic body that defines the exposed portion of the surface of the unfired ceramic body, and thereby forming at least a dent in an exposed portion of the unfired ceramic body.

2. A method according to claim 1, wherein the step of covering comprises:
producing the cover separately from the unfired ceramic body, and
holding, with a holder, the cover such that the cover is kept in close contact with the surface of the unfired ceramic body.

3. A method according to claim 1, wherein the step of covering comprises bonding the cover to the surface of the unfired ceramic body, and wherein the method further comprises the step of separating, after the step of removing, the cover from the surface of the unfired ceramic body.

4. A method according to claim 1, wherein the step of removing comprises causing an active medium to act on the exposed portion of the surface of the unfired ceramic body, and at least a portion of the cover that is adjacent to the exposed portion of the surface, and thereby physically removing at least said portion of the unfired ceramic body that defines the exposed portion of the surface.

5. A method according to claim 4, wherein the active medium comprises a solid.

6. A method according to claim 4, wherein the active medium comprises a liquid.

7. A method according to claim 4, wherein the active medium comprises a gas.

8. A method according to claim 1, wherein the unfired ceramic body comprises an unfired ceramic sheet, and wherein the step of removing comprises removing at least one portion of the unfired ceramic sheet that is not covered by the cover, and thereby forming at least one through-hole through a thickness of the unfired ceramic sheet.

9. A method according to claim 8, wherein the step of removing comprises forming a plurality of through-holes along a single line in the unfired ceramic sheet, and thereby providing a perforated portion of the unfired ceramic sheet.

10. A method according to claim 9, further comprising the step of bonding a support sheet to an opposite surface of the unfired ceramic sheet that is opposite to the surface thereof covered by the cover.

11. A method according to claim 9, wherein the step of covering comprises covering, with a first cover having a plurality of first through-holes formed along a single line, the surface of the unfired ceramic sheet, such that the first cover is kept in close contact with the unfired ceramic sheet, wherein the step of removing comprises forming, in the unfired ceramic sheet, an array of through-holes corresponding to the plurality of first through-holes of the first cover, wherein the step of covering further comprises covering, with a second cover having at least one second through-hole corresponding to at least one portion of the first cover that is located between at least one pair of adjacent first through-holes of the plurality of first through-holes, the unfired ceramic sheet having the array of through-holes, such that the second cover is kept in close contact with the unfired ceramic sheet, and wherein the step of removing further comprises removing at least one portion of the unfired ceramic sheet that is located between at least one pair of adjacent through-holes of the array of through-holes, and thereby connecting the array of through-holes with each other so as to form a slit.

12. A method according to claim 11, further comprising the step of bonding a support sheet to an opposite surface of the unfired ceramic sheet that is opposite to the surface thereof covered by the cover.

13. A method according to claim 9, wherein the step of covering comprises covering, with a first cover having a plurality of first through-holes formed along a single line, the surface of the unfired ceramic sheet, such that the first cover is kept in close contact with the unfired ceramic sheet, wherein the step of removing comprises forming, in the unfired ceramic sheet, an array of through-holes corresponding to the plurality of first through-holes of the first cover, wherein the step of covering further comprises covering, with a second cover having at least one second through-hole corresponding to at least one portion of the first cover that is located between at least one pair of adjacent first through-holes of the plurality of first through-holes, the unfired ceramic sheet having the array of through-holes, such that the second cover is kept in close contact with the unfired ceramic sheet, and wherein the step of removing further comprises forming at least one through-hole in at least one portion of the unfired ceramic sheet that is located between at least one pair of adjacent through-holes of the array of through-holes.

14. A method according to claim 13, further comprising the step of bonding a support sheet to an opposite surface of the unfired ceramic sheet that is opposite to the surface thereof covered by the cover.

15. A method according to claim 8, further comprising the step of forming, in the unfired ceramic sheet, at least one electrically conductive portion by filling said at least one through-hole of the unfired ceramic sheet with at least one electrically conductive body, and forming an electrically conductive layer on at least one of the opposite surfaces of the unfired ceramic sheet.

16. A method according to claim 15, wherein the step of forming said at least one electrically conductive layer comprises forming, on said at least one of the opposite surfaces of the unfired ceramic sheet, at least one circuit pattern which is electrically connected to said at least one electrically conductive portion of the unfired ceramic sheet.
